(19) United States
(12) Patent Application Publication
(10) Pub. No.: US 2010/0288573 A1
(43) Pub. Date: Nov. 18, 2010

(54) VEHICLE DRIVER STATE DETECTION APPARATUS

(75) Inventor: Tamiko Nishina, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/744,274

(22) PCT Filed: Nov. 21, 2008
(86) PCT No.: PCT/IB2008/003166

§ 371 Date: May 21, 2010

(30) Foreign Application Priority Data
Nov. 22, 2007 (JP) 2007-302927

(51) Int. Cl. B60K 28/06; B60R 21/05

(52) U.S. Cl. 180/272

(57) ABSTRACT

A vehicle driver state detection apparatus includes: a panel surface that includes an instrument panel or a meter cluster; a steering column portion that supports a steering shaft of a vehicle; a displacement absorbing portion that absorbs displacement caused by an impact applied to the steering column portion in an axial direction of the steering column portion; and a driver state detection portion attached to an outer peripheral surface of the steering column portion . In the vehicle driver state detection apparatus, the driver state detection portion is provided at a portion at which the driver state detection portion does not contact the panel surface when the displacement is absorbed.

### FIELD OF THE INVENTION

The invention relates to a vehicle driver state detection apparatus that detects the state of a vehicle driver, and, in particular, relates to a vehicle driver state detection apparatus that includes a detection portion provided on a steering column.

### BACKGROUND OF THE INVENTION

A drive assist technology is available, in which a facial image of a driver is captured to determine a driver's face orientation and whether the driver is napping, in order to assist driving operation of the driver. As shown in FIG. 9, Japanese Patent Application Publication No. 2007-69681 (JP-A-2007-69681) describes a structure in which a camera 110 is disposed on an upper side of an upper cover 113 of a steering column 112, because, when the camera 110 is designed to capture the facial image of the driver, it is preferable that the camera 110 be disposed at a position that allows the camera 110 to easily capture the facial image of the driver.

FIG. 9A is a side view schematically showing the structure in which the camera 110 is mounted, and FIG. 9B shows the structure in which the camera 110 is mounted, when viewed from the driver's seat. If the camera 110 is disposed at the position as shown in FIGS. 9A and 9B, it is possible to capture the images of characteristic portions of the face (such as eyes, nose, and mouth) that are required for drive assist.

For example, a double-tube steering shaft including an inner tube and an outer tube is configured so that, when a vehicle collides with an obstacle, an impact produced by the collision is absorbed using sliding resistance produced by sliding movement of the inner tube inside the outer tube. Therefore, in the structure in which the camera 110 is mounted shown in FIG. 9A, a desired stroke of movement may not be ensured because, when an upper cover 113, as well as the steering column 112, is moved forward with respect to the vehicle at the time of a collision, the camera 110 may interfere with a meter panel 114 during movement of the steering column 112.

Further, as shown in FIG. 9B, in the structure in which the camera is mounted in JP-A-2007-69681, the meter panel 114 is partially obstructed by the camera 110, and therefore, visibility of the meter is degraded. Further, when the camera 110 is disposed on the upper side of the upper cover 113, the camera 110 comes into sight of occupants, and thus, the design is degraded. Further, because the upper side of the upper cover 113 is exposed to direct sunlight, the camera 110 is affected by high temperature, thermal expansion, and ultraviolet ray, etc., resulting in degradation of performance of the camera 110.

### SUMMARY OF THE INVENTION

The invention provides a vehicle driver state detection apparatus that does not interrupt movement of a steering column when an impact is absorbed.

A first aspect of the invention relates to a vehicle driver state detection apparatus. The vehicle driver state detection apparatus includes: a panel surface that includes one of an instrument panel and a meter cluster; a steering column portion that supports a steering shaft of a vehicle; a displacement absorbing portion that absorbs displacement caused by an impact applied to the steering column portion in an axial direction of the steering column portion; and a driver state detection portion that is attached to an outer peripheral surface of the steering column portion. The driver state detection portion is provided on the outer peripheral surface of the steering column portion at a portion at which the driver state detection portion does not contact the panel surface when the displacement is absorbed.

In the vehicle driver state detection apparatus as described above, because the driver state detection portion does not contact the panel surface, the displacement absorbing portion absorbs displacement caused by the impact applied to the steering column portion, and the steering column is moved as designed.

Further, the driver state detection portion may be provided on the outer peripheral surface of the steering column portion at a portion that is distant from the panel surface toward a side of a steering wheel so that the distance between the portion and the panel surface is larger than a maximum amount of the displacement absorbed by the displacement absorbing portion.

In the vehicle driver detection apparatus as described above, because the distance between the panel surface and the driver state detection portion is larger than the maximum amount of the displacement, the driver state detection portion is prevented from contacting the panel surface when the displacement is absorbed.

A second aspect of the invention relates to a vehicle driver state detection apparatus. The vehicle driver state detection apparatus includes: a meter cluster; a steering column portion that supports a steering shaft of a vehicle; a displacement absorbing portion that absorbs displacement caused by an impact applied to the steering column portion in an axial direction of the steering column portion; and a driver state detection portion attached to an outer peripheral surface of the steering column portion. The driver state detection portion is provided at a portion on the outer peripheral surface of the steering column portion so that an angle formed between the portion of the outer peripheral surface and a surface of the meter cluster is obtuse.

In the vehicle driver state detection apparatus as described above, because the driver state detection portion is provided at a portion on the outer peripheral surface of the steering column portion so that an angle formed between the panel surface and the portion at which the driver state detection portion is provided is obtuse, it is possible to avoid interruption of movement of the steering column portion by the driver state detection portion, even when the driver state, detection portion contacts the panel surface.

In the vehicle driver detection apparatus according to the second aspect of the invention, the driver state detection portion may be provided so that the driver state detection portion is detached from the outer peripheral surface of the steering column portion when a predetermined or larger external force is applied to the driver state detection portion.

According to the second aspect of the invention, the vehicle driver state detection apparatus may include a detachment mechanism that detaches the driver state detection portion from the outer peripheral surface of the steering column portion when a predetermined or larger external force is applied to the driver state detection portion.

Further, in the vehicle driver state detection apparatus according to the aforementioned aspects of the invention, the driver state detection portion may be provided at a portion on the outer peripheral surface of the steering column portion so that the driver state detection portion does not come into sight of a driver.

Further, in the vehicle driver state detection apparatus according to the aforementioned aspects of the invention, the driver state detection portion may be provided on the outer peripheral surface of the steering column portion at a portion that is opposed to a floor surface of the vehicle.

In the configurations as described above, it is possible to dispose the driver state detection portion on the outer peripheral surface of the steering column portion at the portion at which the driver state detection portion does not contact the panel surface, and therefore, it is possible to avoid interruption of movement of the steering column portion by the driver state detection portion.

Further, in the vehicle driver state detection apparatus according to the aforementioned aspects of the invention, the driver state detection portion may include an imaging device. In this configuration, it is possible to detect whether the driver takes eyes off the road or whether the driver is napping using the imaging device provided on the steering column.

The driver state detection portion may further include a projector that projects light to the driver.

Further, a plurality of the driver state detection portions may be provided at two or more portions on the outer peripheral surface of the steering column portion.

As described above, it is possible to provide the vehicle driver state detection apparatus that does not interrupt movement of the steering column portion when the displacement is absorbed.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a side view schematically showing a structure in which a camera assembly is mounted;

FIGS. 2A and 2B are cross-sectional views schematically showing the structure in which the camera assembly is mounted;

FIG. 3 shows the camera assembly viewed from a driver's seat;

FIG. 4A is a front view of the camera assembly, and FIG. 4B is a side view of the camera assembly;

FIG. 5 is a side view schematically showing a state before a steering column is moved and a state after the steering column is moved;

FIGS. 6A and 6B show examples of arrangement of the camera assembly viewed from the driver's seat;

FIGS. 7A and 7B are side views schematically showing a structure in which a camera assembly is mounted in related art, and FIG. 7C is a side view schematically showing a structure in which a camera assembly is mounted according to a second embodiment of the invention;

FIG. 8 is a cross-sectional view schematically showing another example of a state where the camera assembly interferes with a meter assembly; and

FIGS. 9A and 9B show an example of a structure in which a camera is mounted according to related art.

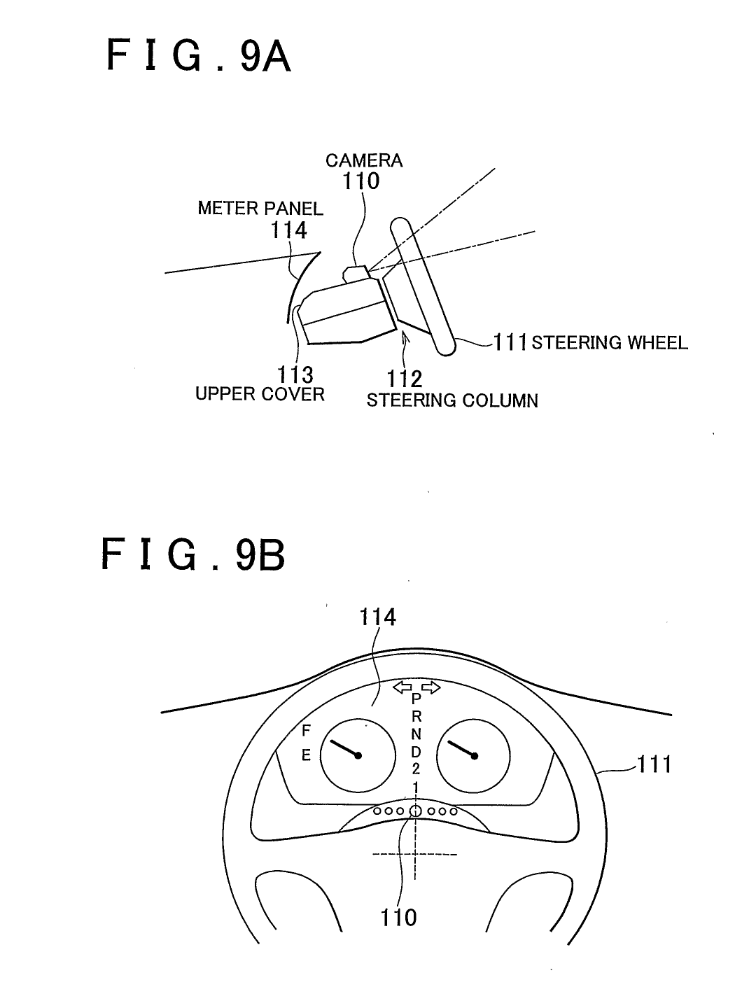

### DETAILED DESCRIPTION OF THE EXAMPLE EMBODIMENTS

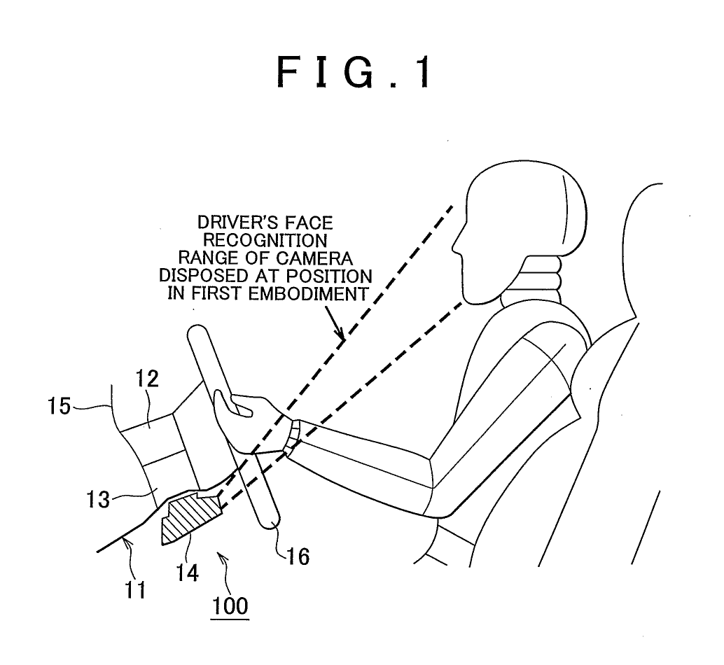

FIG. 1 is a side view schematically showing a driver state detection apparatus 100 according to a first embodiment of the invention. In the driver state detection apparatus 100 shown in FIG. 1, a camera assembly 14 is disposed on a lower surface of a lower cover 13 fitted to a steering column assembly 11. There is a space below a lower surface of the steering column 11 to allow a driver to operate an accelerator pedal, etc., by foot. Therefore, even when a steering shaft 20 is moved due to a collision, there is no possibility that the camera assembly 14 interferes with a partition wall that separates a vehicle compartment and an engine room, because there is enough space between the camera assembly 14 and the partition wall. As a result, the camera assembly 14 is not significantly impacted by the collision. Further, because a lower cover 13 fitted to the steering column 11 is hidden behind the steering wheel 16 when viewed from the driver's seat side, the arrangement of the camera assembly 14 does not affect the design. Moreover, because the camera assembly 14 is disposed at a position that is distant from a meter substrate 21 provided in front of a protective panel 15 with respect to a vehicle, the camera assembly 14 does not affect visibility of the meter substrate 21. Furthermore, because the camera assembly 14 is not exposed to direct sunlight, it is possible to suppress degradation of performance of the camera assembly 14 caused due to exposure to high temperature.

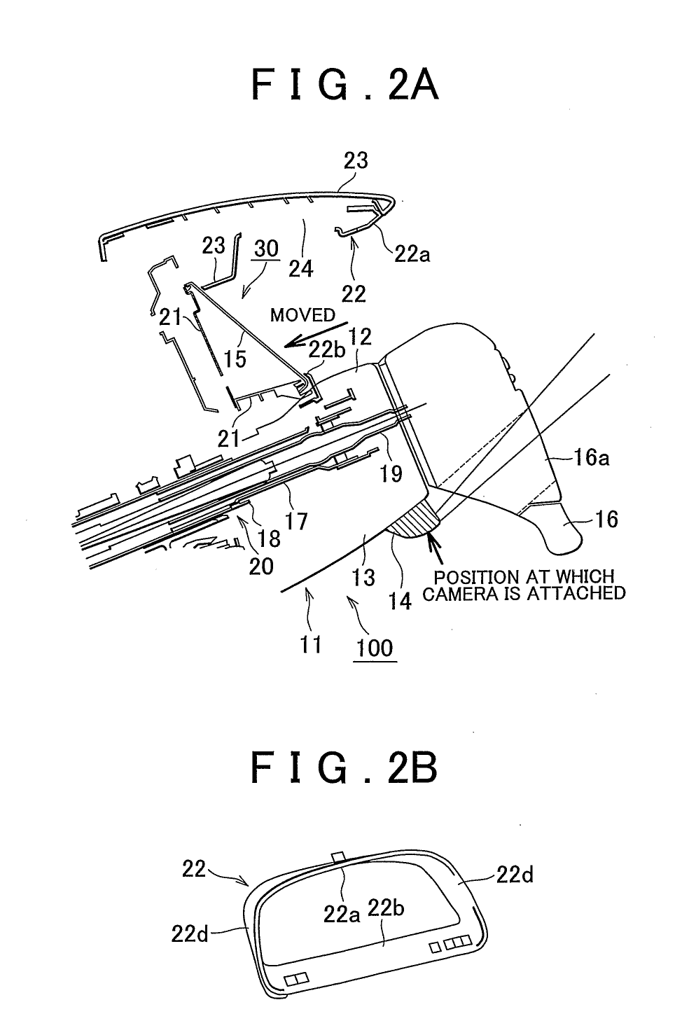

FIG. 2A is a cross-sectional view schematically showing a driver state detection apparatus 100 according to the first embodiment of the invention, and FIG. 2B is a perspective view showing an example of a meter cluster 22. A meter assembly 30 is provided in front of an upper cover 12 with respect to the vehicle, and is fitted to a lower portion of an instrument panel 23. The meter assembly 30 includes the meter substrate 21, the protective panel 15 that protects the meter substrate 21 and is made of a transparent material, such as glass or transparent resin (or, a semitransparent material such as a half mirror), and the meter cluster 22 that is disposed to surround the protective panel 15. The instrument panel 23 is provided with an opening portion 24, and a projector (not shown) is disposed in the opening portion 24 so as to project images on the meter substrate 21.

As shown in FIG. 2B, the meter cluster 22 includes an opening that is formed as a frame so as to allow occupants, for example, the driver, to look at the meter substrate 21. The meter cluster 22 also includes an upper side member 22a that is fitted to the instrument panel 23, a lower side member 22b disposed close to the upper cover 12, and left and right column members 22d. It should be noted that the upper side member 22a is partially omitted in FIG. 2B. Further, the lower side member 22b is placed on the upper cover 12. The meter cluster 22 need not necessarily be frame-shaped, and need not necessarily continuously surround the protective panel 15. Further, the meter cluster 22 may be appropriately designed in any shape, such as an oval shape or a polygonal shape, in accordance with the desired visibility and design.

The steering shaft 20 includes an outer tube 18 and an inner tube 17, and the inner tube 17 is press-fitted into the outer tube 18. The outer tube 18 is fixed to a vehicle body through a bracket. A main shaft 19 is connected to the inner tube 17 and the like though a bearing so that the main shaft 19 rotates coaxially with the inner tube 17 and the like. The steering wheel 16 is fixed to an end portion of the main shaft 19, which is located in a vehicle cabin. Therefore, when the driver operates the steering wheel 16, the main shaft 19 rotates relative to the inner tube 17, and an operation amount of the steering wheel 16 is transmitted to a steering gearbox through a universal joint and an intermediate shaft.

The steering shaft 20 is supported by the bracket, and is pivotable about a predetermined point by moving a position, at which the steering shaft 20 is supported by the bracket, upward and downward by manual operation or an actuator. The steering wheel 16 is tiltable within a predetermined angle range in accordance with the pivot movement of the steering shaft 20. Further, the bracket includes a guide groove that extends in an axial direction of the steering shaft 20. An engagement portion of the steering shaft 20, which engages with the guide groove, is moved relative to the bracket so as to adjust the steering wheel 16 forward and rearward with respect to the vehicle in the axial direction of the steering shaft 20.

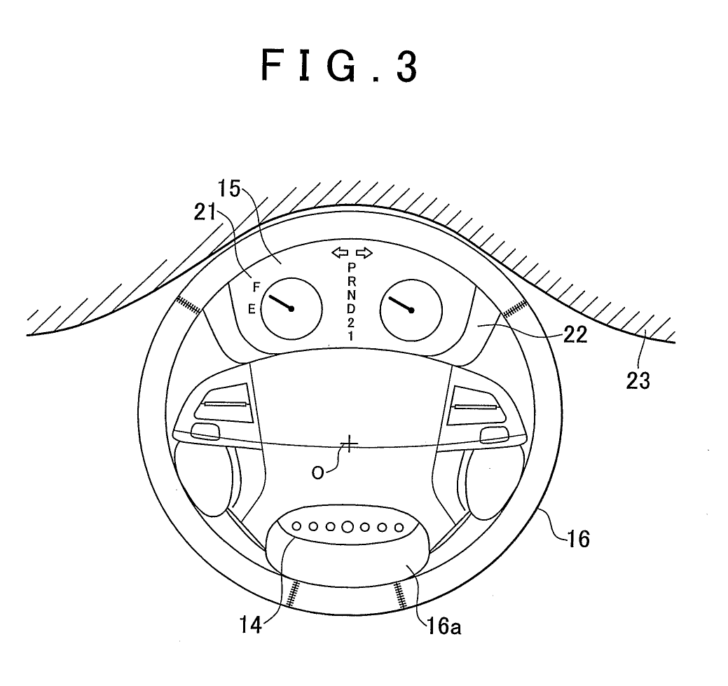

FIG. 3 shows the camera assembly 14 viewed from a driver's seat. A camera 33 is disposed so that an optical axis is directed toward the driver's face (that is, directed rearward and diagonally upward with respect to the vehicle) through a sector-shaped opening portion 16a that is defined by a circumferential portion and spokes of the steering wheel 16. The camera 33 has a predetermined angle of view, and captures an image of the entire face of the driver of the vehicle from substantially the front.

In order to capture the image of the entire face of the driver without interrupting the angle of view of the camera 33, the opening portion 16a is enlarged in a direction toward a center O of the steering wheel 16 by the height of the camera assembly 14, compared to the case where the camera assembly 14 is disposed on the upper cover 12. More specifically, the opening portion 16a opens in a vertical direction of the vehicle with respect to a straight line formed by connecting the optical axis of the camera 33 and a center of the driver's face in a manner such that a predetermined angle of view (for example, 10° to)30° is not interrupted. When the steering wheel 16 is tilted, a relationship between relative positions of the driver's face and the camera assembly 14 is changed. However, the opening portion 16a opens to allow the camera 33 to capture the image of the entire face of the driver even when a tilt angle is minimum (note that when the steering shaft 20 is positioned in the horizontal direction, the tilt angle is 0° , and when the steering shaft 20 is positioned in a vertical direction, the tilt angle is)90° .

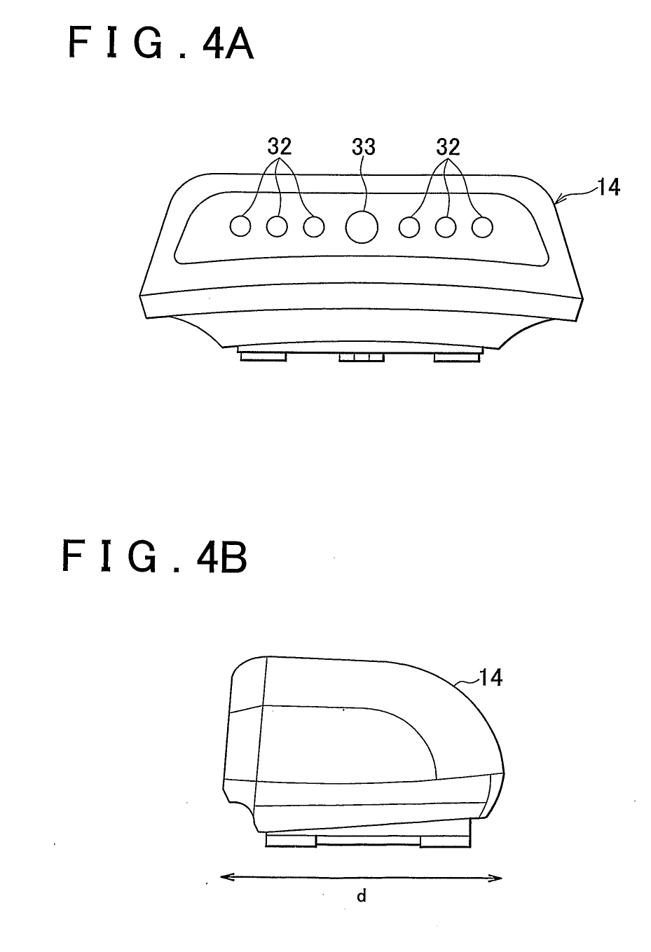

FIG. 4A is a front view of the camera assembly 14, and FIG. 4B is a side view of the camera assembly 14. The camera assembly 14 includes a casing 31 in which the camera 33 and the infrared projectors 32 are housed. The camera 33 is disposed at the center of the camera assembly 14, and is positioned on a vertical axis that extends through the center O of the steering wheel 16.

The camera 33 includes a charge coupled device (CCD) or a complementary metal oxide semiconductor (CMOS). The camera 33 is sensitive to the infrared light (with a peak wavelength of around 870 nm) radiated by the infrared projectors 32, and produces digital data (facial image) at a predetermined gradation after converting the incident light into electricity. When the camera assembly 14 is disposed on the lower surface of the lower cover 13 fitted to the steering column 11, the camera assembly 14 shown in FIG. 4A is disposed upside down.

Further, the number of the infrared projectors 32 disposed on the left side of the camera 33 is the same as the number of the infrared projectors 32 disposed on the right side of the camera 33 in the camera assembly 14 (in FIG. 4A, the number of the infrared projectors 32 is 3 on each side). Each of the infrared projectors 32 is a LED lamp that projects near-infrared light toward the driver's face, and allows the camera 33 to capture the facial images of the driver even at night. The number of the infrared projectors 32 disposed on each side of the camera 33 is the same because, when the driver faces substantially the front (the driver does not take eyes off the road), it is possible to equalize the illuminance of the near-infrared light projected toward the left side of the driver's face, and the illuminance of the near-infrared light projected toward the right side of the driver's face. This makes it possible to easily and appropriately detect characteristic portions of the driver's face, such as a width and a center line of the driver's face, based on the facial images captured at night. Thus, it is possible to accurately detect a driver's face orientation angle.

The camera 33 and the infrared projectors 32 are controlled by a computer (hereinafter referred to as an “image processing portion”). For example, the image processing portion controls the infrared projectors 32 to emit light 60 times per second so as to irradiate the driver's face with the near-infrared light, and controls the camera 33 to capture the images of the driver's face irradiated with the near-infrared light at 30 frames (that is, 60 fields) per second and send the captured images to the image processing portion.

The image processing portion extracts edge information based on the facial images sent from the camera 33, and produces an edge image in which the facial images are binarized by comparing edge strength and a threshold. Then, the image processing portion creates a histogram by projecting edge points of the edge image downward in a vertical direction so as to detect both sides of the face indicated by peaks in the histogram.

Further, the image processing portion detects the center line of the driver's face so that the number of edge points on the right side of the center line is equal to that on the left side of the center line, and calculates the driver's face orientation angle based on a proportion between an area of a left portion and an area of a right portion of the face, which are the areas from the center line to the sides of the face: The driver's face orientation angle is 0° when the driver faces straightforward in a traveling direction of the vehicle along a traveling lane when the vehicle is traveling straight, and, for example, the orientation angle when the driver looks to the right is a positive value.

Further, the image processing portion detects the positions of nostrils, which are relatively easy to detect, based on the facial images. Then, an eye movement tracking region is set based on the positions of the nostrils using statistic information on the positional relationship between the nostrils and the eyes. The image processing portion counts the time during which the driver's eyes are opened and the time during which the driver's eyes are closed based on the captured images. When the driver's eyes are closed for a predetermined time or longer, the image processing portion determines that the driver is napping or the driver becomes very drowsy.

A drive assist apparatus of the vehicle, for example, provides a warning in accordance with the detected driver's face orientation angle and drowsiness, or changes a timing for starting a warning (advances the timing for starting a warning) in order to start a warning before the vehicle collides with an obstacle in front of the vehicle.

Next, the advantageous effects obtained by the driver state detection apparatus 100 according to the first embodiment will be described. As shown in FIG. 2, when the vehicle collides with the obstacle, the inner tube 17 slides inside the outer tube 18 so as to absorb a collision impact. During this, the steering column 11 and the steering wheel 16 are moved forward with respect to the vehicle. The distance between the steering wheel 16 and the driver is extended by the movement as described above, and it is possible to form the space that is large enough to deploy an airbag.

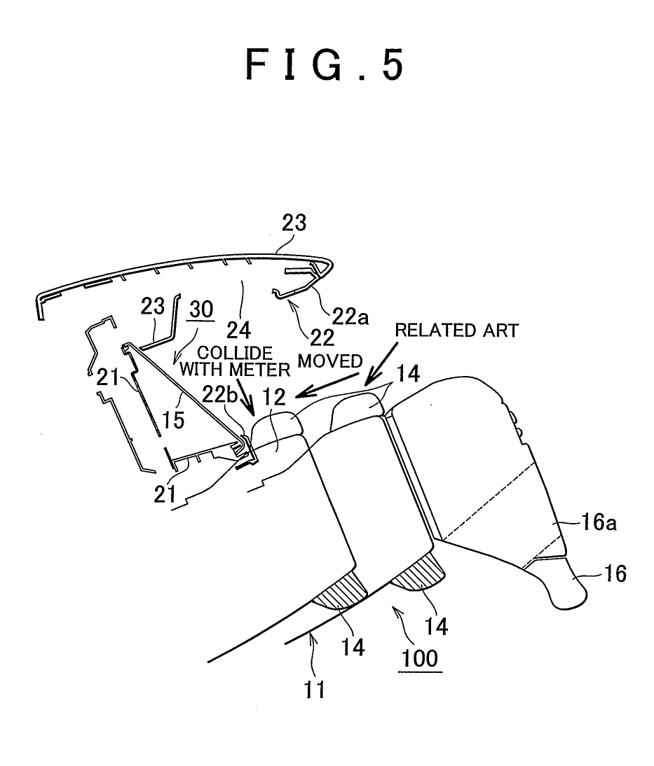

FIG. 5 is a side view schematically showing a state before the steering column 11 is moved, and a state after the steering column 11 is moved. The stroke of movement is, for example, around 70 to 100 [mm] at maximum. In the case where the camera assembly 14 is disposed on the upper cover 12 as shown in FIG. 5 for comparison with the first embodiment according to the invention, when the steering column 11 is moved, the camera assembly 14 interferes with the protective panel 15, or, the meter cluster 22, in particular, the lower side member 22b of the meter cluster 22, and the movement of the steering column 11 is interrupted at the point where the camera assembly 14 interferes with the component as described above. In order to ensure designed stroke of movement when the camera assembly 14 is disposed on the upper cover 12, it is required to change designs of various components, for example, it is required to reduce a length d (as shown in FIG. 4B) of the camera assembly 14 in the axial direction of the steering column 11, or to dispose the protective panel 15 and the meter substrate 21 further forward with respect to the vehicle. These design changes result in an increase of cost.

In contrast, when the camera assembly 14 is disposed on the lower surface of the lower cover 13 as in the driver state detection apparatus 100 according to the first embodiment of the invention, a distance between a front end portion of the camera assembly 14 with respect to the vehicle and the partition wall that separates the vehicle compartment and the engine room is equal to or larger than the designed stroke of movement. Therefore, it is possible to avoid interruption of movement of the steering column 11 for absorbing the impact.

Further, the camera assembly 14 is disposed at the position at which the camera assembly 14 is hidden from eyesight of the occupants, for example, the driver, and therefore, the design is improved. Further, when the driver looks at the meter substrate 21, the camera assembly 14 does not come into sight, and therefore, it is possible to improve visibility of the meter substrate 21. Further, because the camera assembly 14 is disposed at the position at which the camera assembly 14 is not exposed to direct sunlight, it is possible to suppress degradation of performance of the camera assembly 14.

Further, when the image processing portion detects the driver's face orientation angle and detects whether the driver's eyes are opened or closed by capturing the facial images of the driver, the center line of the driver's face is detected in the manner as described above. When the camera assembly 14 is disposed on the lower surface of the lower cover 13, an elevation angle of the camera 33 is increased, and as a result, the facial image of the driver is captured so that the nasal apex (tip of nose) of the driver protrudes from other portions of the driver's face. This makes it possible to easily detect the center line of the driver's face based on the nasal apex in the captured image, and therefore, it is possible to detect the driver's face orientation angle quickly. Further, because the nostrils are easily detected due to the increased elevation angle of the camera 33, it is possible to easily set the eye movement tracking region, and therefore, it is more quickly detected whether the driver's eyes are opened or closed.

If it is not necessary to change designs of the components, or such design change of the components is allowed, the camera assembly 14 may be disposed on the upper cover 12. In other words, it may be designed n a manner such that, when the camera assembly 14 is disposed on the upper cover 12, the distance between an end portion of the camera assembly 14 on the front side with respect to the vehicle and the meter cluster 22, etc. is larger than the stroke of movement in which the steering column 11 is moved due to a collision. In this configuration, it is possible to avoid interference between the camera assembly 14 and the meter cluster 22, etc., even when the steering column 11 is moved due to the collision.

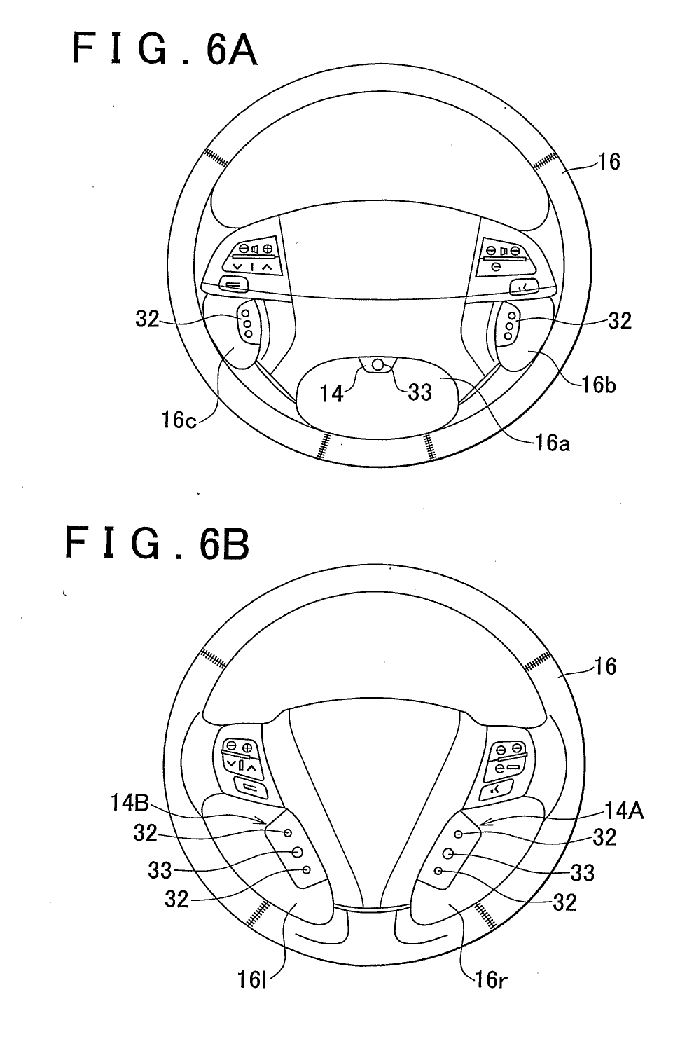

Next, a modification example of the driver state detection apparatus 100 will be described. In FIG. 4, the camera 33 and the infrared projectors 32 are integrated into one assembly. However, the camera 33 and the infrared projectors 32 may be formed separately from each other. FIG. 6A shows the driver state detection apparatus 100 in which the camera 33 and the infrared projectors 32 are formed separately from each other. The camera 33 is disposed so that the camera 33 can be seen through the opening portion 16a, and the infrared projectors 32 are disposed at positions on the left side and on the right side of the steering column 11 so that the infrared projectors 32 can be seen through opening portions 16b, 16c. When the infrared projectors 32 are disposed on the left side and on the right side of the steering column 11, it is possible to equalize the illuminance of the infrared light projected toward the left side of the driver's face, and the illuminance of the infrared light projected toward the right side of the driver's face when the driver looks substantially forward. Furthermore, it is possible to reduce the size of the opening portion 16a because the camera assembly 14 does not need to include the infrared projectors 32. Accordingly, it is possible to reduce design restrictions.

Further, in FIGS. 3 and 6A, the camera assembly 14 is disposed on the steering column 11 taking into account the opening portion 16a of the four-spoke steering wheel 16. However, the camera assembly 14 may be disposed on the steering column 11 that includes three-spoke steering wheel 16.

FIG. 6B shows one example of the driver state detection apparatus 100 when the camera assembly 14 is disposed on the steering column 11 that includes the three-spoke steering wheel 16. In FIG. 6B, two camera assemblies 14A, 14B are disposed in a lower left side portion and a lower right side portion of the steering column 11, respectively, when viewed from the driver's seat. When viewed from the driver's seat, the camera 33 on the right side captures the facial image of the driver from the slightly right side through an opening portion 16r, and the camera 33 on the left side captures the facial image of the driver from the slightly left side through an opening portion 161. Because the facial images of the driver are used for determining the driver's face orientation angle, it is preferable that the camera 33 should capture the facial images of the driver from the front. However, when the cameras 33 are disposed in symmetric positions on the left side and the right side of the steering column 11, respectively, and, for example, the images captured from the left side and the right side are cut at the center of the face, and one side of the cut image captured from the left side is combined with the other side of the cut image captured from the right side, it is possible to detect the driver's face orientation angle and whether the driver's eyes are opened or closed, as they are detected in the case where the images are captured from the front. Further, either of the camera assembly 14A or the camera assembly 14B may be mounted on the steering column 11 so that the image processing portion detects the driver's face orientation angle and whether the driver's eyes are opened or closed, by correcting the captured images into the image of the front face.

Next, a second embodiment of the invention will be described. In the driver state detection apparatus 100 according to the first embodiment, the camera assembly 14 is disposed at the position that allows the camera assembly 14 to avoid interference with the protective panel 15 even when the steering column 11 is moved in order to absorb the impact. However, the camera assembly 14 may be disposed on the upper cover 12 at the position at which the camera assembly 14 interferes with the meter assembly 30 when the steering column 11 is moved, as long as the camera assembly 14 does not interrupt the movement of the steering column 11.

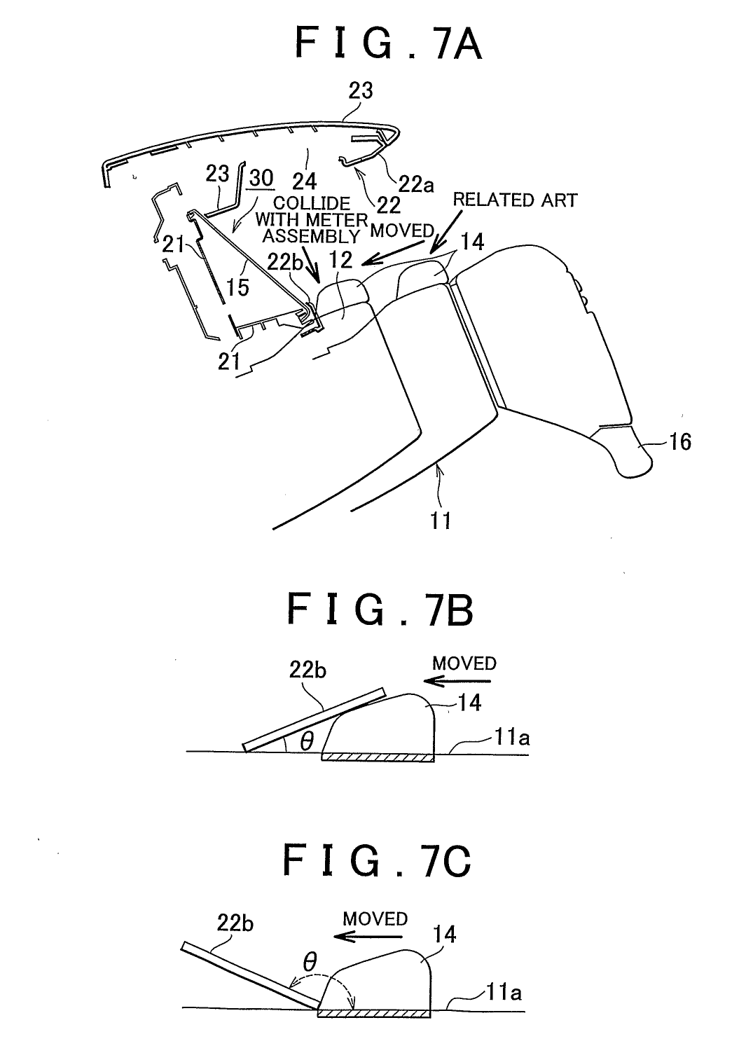

FIG. 7A is a cross-sectional view schematically showing a state where the camera assembly 14 interferes with the meter assembly 30. It should be noted that, in FIG. 7A, the same elements as in FIG. 2 are denoted by the same reference numerals, and the description thereof will be omitted. In FIG. 7A, the camera assembly 14 interferes with the protective panel 15 due to the movement of the steering column 11, and in addition, interferes with the lower side member 22b of the meter cluster 22. In other words, when the impact is absorbed, the steering column 11 is moved below the lower side member 22b, and therefore, the camera assembly 14 interferes with the lower side member 22b of the meter cluster 22. The meter cluster 22 has high strength, and the lower side member 22b has a certain width in the direction in which the steering column 11 is moved. Therefore, the meter cluster 22 and the lower side member 22b strongly interrupt the movement of the steering column 11.

FIG. 7B shows an example of a relationship between the lower side member 22b and the camera assembly 14 that interferes with the lower side member 22b.

Assuming that an angle formed between an attachment surface 11a of the steering column 11 on which the camera assembly 14 is attached and the lower side member 22b is θ, the camera assembly 14 is disposed at a portion on the attachment surface 11a so that the angle θ is acute. When the camera assembly 14 is moved toward the lower side member 22b that forms the acute angle θ with the portion of the attachment surface 11a, the camera assembly 14 is pressed between the lower side member 22b and the steering column 11 as the camera assembly 14 is moved, and thus, the lower side member 22b strongly interrupts the movement of the steering column 11.

As shown in FIG. 7C, if the camera assembly 14 is disposed at a portion on the attachment surface 11a so that the angle θ between the portion of the attachment surface 11a and the lower side member 22b is obtuse, the camera assembly 14 runs on the lower side member 22b and interferes with the meter cluster 22, and therefore, movement of the steering column 11 is not strongly interrupted. Therefore, if the camera assembly 14 is disposed at the portion on the attachment surface 11a so that the angle θ is obtuse as shown in FIG. 7C, it is possible to ensure the designed stroke of movement even when the camera assembly 14 interferes with the protective panel 15 during movement of the steering column 11.

Further, if the camera assembly 14 is attached to the steering column 11 in a manner such that the camera assembly 14 is detached from the attachment surface 11a due to a predetermined or larger external force applied from the meter cluster 22, the steering column 11 can be moved as designed, because the camera assembly 14 is detached from the attachment surface 11a when the camera assembly 14 interferes with the meter cluster 22. The camera assembly 14 may be fixed on the attachment surface 11a by means of a hook that is detached by a reaction force applied from the meter cluster 22 or may be fixed by means of a connection wire that is broken at a predetermined or larger tension, in addition to the electrical connection between the camera assembly 14 and the image processing portion. In this case, it should be noted that the camera assembly 14 is detached from the attachment surface 11a even in the state shown in FIG. 7B. As a result, it is possible to reduce the effect of interrupting the movement of the steering column 11 by the camera assembly 14.

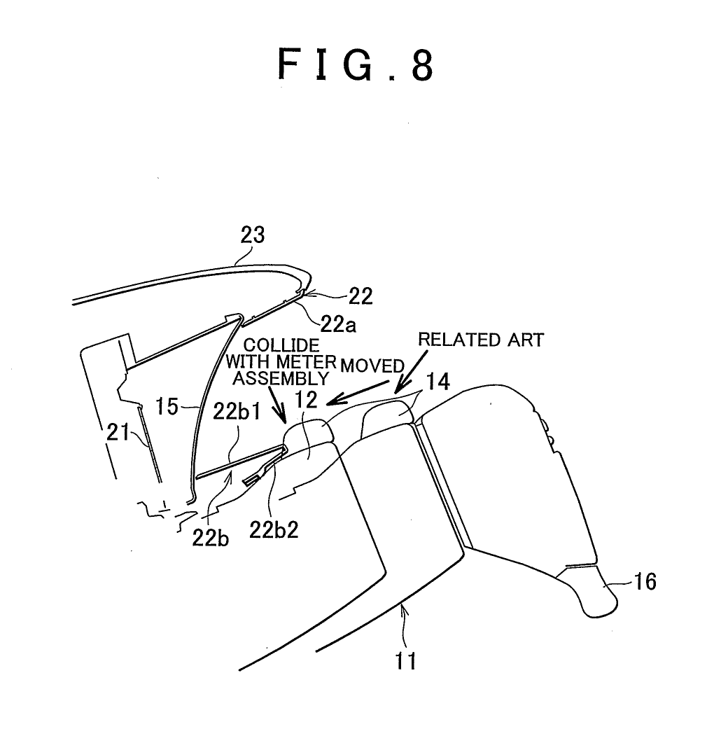

FIG. 8 is a cross-sectional view schematically showing another example of a state where the camera assembly 14 interferes with the meter assembly 30. In FIG. 8, the same elements as in FIG. 2 are denoted by the same reference numerals, and the description thereof will be omitted. In FIG. 8, the protective panel 15 is retained by the meter assembly 30 in a manner such that an upper side of the protective panel 15 is inclined toward a rear of the vehicle (toward the driver's seat). Further, the lower side member 22b is bent at more acute angle. In this configuration, it is possible to ensure a sufficient distance between the front end portion of the camera assembly 14 with respect to the vehicle and the protective panel 15. In FIG. 8, the angle θ formed between a lower side member 22b1 of the meter cluster and the attachment surface 11a of the camera assembly 14 is obtuse. In contrast, the angle θ formed between a lower side member 22b2 and the attachment surface 11a of the camera assembly 14 is acute. When the steering column 11 is moved, the camera assembly 14 interferes with the boundary between the lower side member 22b1 and the lower side member 22b2, and therefore, the angle θ formed between the boundary and the attachment surface 11a is obtuse, as in the case where the camera assembly 14 interferes with the lower side member 22b1. Therefore, even when the exemplary configuration of the meter assembly 30 shown in FIG. 8 is employed, it is possible to reduce the effect of interrupting the movement of the steering column 11 by the meter cluster 22. Further, the meter assembly 30 shown in FIG. 8 may be applied to the case where the camera assembly 14 is disposed on the lower cover 13, as shown in FIG. 2.

With the driver state detection apparatus 100 according to the second embodiment, it is possible to easily ensure the designed stroke of movement for the steering column 11 even when the camera assembly 14 interferes with the protective panel 15. Further, when the camera assembly 14 is detached due to the interference with the meter cluster 22, it is possible to ensure the designed stroke of movement. It should be noted that the driver state detection apparatus 100 according to the second embodiment may be combined with the driver state detection apparatus 100 according to the first embodiment.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A vehicle driver state detection apparatus, comprising:
a panel surface that includes one of an instrument panel and a meter cluster;
a steering column portion that supports a steering shaft of a vehicle;
a displacement absorbing portion that absorbs displacement caused by an impact applied to the steering column portion in an axial direction of the steering column portion; and
a driver state detection portion that is attached to an outer peripheral surface of the steering column portion,
wherein the driver state detection portion is provided on the outer peripheral surface of the steering column portion at a portion that is distant from the panel surface toward a side of a steering wheel so that a distance between the portion and the panel surface is larger than a maximum amount of the displacement absorbed by the displacement absorbing portion.

2. (canceled)

3. A vehicle driver state detection apparatus, comprising:
a meter cluster having a lower side member;
a steering column portion that supports a steering shaft of a vehicle;
a displacement absorbing portion that absorbs displacement caused by an impact applied to the steering column portion in an axial direction of the steering column portion; and
a driver state detection portion attached to an outer peripheral surface of the steering column portion;
wherein a portion on the outer peripheral surface of the steering column portion at which the driver state detection portion is provided and a surface of the lower side member of the meter cluster directed to the driver state detection portion form an obtuse angle, and
wherein the driver state detection portion is provided so that the driver state detection portion is detached from the outer peripheral surface of the steering column portion when a predetermined or larger external force is applied to the driver state detection portion.

4. (canceled)

5. The vehicle driver state detection apparatus according to claim 3, further comprising
a detachment mechanism that detaches the driver state detection portion from the outer peripheral surface of the steering column portion when a predetermined or larger external force is applied to the driver state detection portion.

6. The vehicle driver state detection apparatus according to claim 1, wherein the driver state detection portion is provided at a portion on the outer peripheral surface of the steering column portion outside a line of sight from the driver's eye to the meter cluster when the driver is taking a driving position.

7. The vehicle driver state detection apparatus according to claim 1, wherein the driver state detection portion is provided on the outer peripheral surface of the steering column portion at a portion that is opposed to a floor surface of the vehicle.

8. The vehicle driver state detection apparatus according to claim 1, wherein the driver state detection portion includes an imaging device.

9. The vehicle driver state detection apparatus according to claim 8, wherein the driver state detection portion further includes a projector that projects light to the driver.

10. The vehicle driver state detection apparatus according to claim 1, wherein a plurality of the driver state detection portions are provided at two or more portions on the outer peripheral surface of the steering column portion.

11. The vehicle driver state detection apparatus according to claim 3, wherein the driver state detection portion is provided at a portion on the outer peripheral surface of the steering column portion outside a line of sight from the driver's eye to the meter cluster when the driver is taking a driving position.

12. The vehicle driver state detection apparatus according to claim 3, wherein the driver state detection portion is provided on the outer peripheral surface of the steering column portion at a portion that is opposed to a floor surface of the vehicle.

13. The vehicle driver state detection apparatus according to claim 3, wherein the driver state detection portion includes an imaging device.

14. The vehicle driver state detection apparatus according to claim 13, wherein the driver state detection portion further includes a projector that projects light to the driver.

15. The vehicle driver state detection apparatus according to claim 3, wherein a plurality of the driver state detection portions are provided at two or more portions on the outer peripheral surface of the steering column portion.
